(19) United States
(12) Patent Application Publication
(10) Pub. No.: US 2020/0220223 A1
(43) Pub. Date: Jul. 9, 2020

(54) IONIC LIQUID ELECTROLYTES FOR HIGH VOLTAGE BATTERY APPLICATION

(71) Applicant: GM GLOBAL TECHNOLOGY OPERATIONS LLC, Detroit, MI (US)

(72) Inventors: Meinan HE, Sterling Heights, MI (US); Shuru CHEN, Troy, MI (US); Mei CAI, Bloomfield Hills, MI (US)

(73) Assignee: GM GLOBAL TECHNOLOGY OPERATIONS LLC, Detroit, MI (US)

(21) Appl. No.: 16/243,509

(22) Filed: Jan. 9, 2019

(51) Int. Cl. H01M 10/0569; H01M 10/0568; H01M 10/0567

(52) U.S. Cl. CPC H01M 10/0569; H01M 2300/0037; H01M 10/0567; H01M 10/0568

(57) ABSTRACT

An ionic liquid electrolyte composition is provided. The ionic liquid electrolyte composition includes an ionic liquid, a conductive salt, and optionally a stabilizing agent. The stabilizing agent is an oxidant, an interface additive, a co-solvent, or a combination thereof.

### INTRODUCTION

This section provides background information related to the present disclosure which is not necessarily prior art.

High-energy density electrochemical cells, such as lithium ion batteries, lithium metal batteries, and lithium sulfur batteries, can be used in a variety of consumer products and vehicles, such as Hybrid Electric Vehicles (HEVs) and Electric Vehicles (EVs). Typical lithium ion, lithium metal, and lithium sulfur batteries comprise a cathode (i.e., a positive electrode), an anode (i.e., a negative electrode), an electrolyte, and a separator. Often a stack of battery cells are electrically connected to increase overall output. Lithium ion and lithium sulfur batteries generally operate by reversibly passing lithium ions between the negative electrode and the positive electrode. A separator and an electrolyte are disposed between the negative and positive electrodes. The electrolyte is suitable for conducting lithium ions and may be in liquid, gel, or solid form. Lithium ions move from a cathode (positive electrode) to an anode (negative electrode) during charging of the battery and in the opposite direction when discharging the battery.

Electrolytes for lithium ion, lithium metal, and lithium sulfur batteries often include a conductive salt, such as LiBF₄ and LiPF₆, solubilized in an organic (e.g., carbonate) solvent. These electrolytes can passivate corrosion defects in aluminum current collectors and have good high voltage stability. However, they are highly volatile and flammable. Ionic liquids are also useful as electrolytes and, beneficially, are not flammable or combustible. However, unlike carbonate-based electrolytes with LiPF₆ salt, which can passivate aluminum current collectors by forming AlF₃, ionic liquid electrolytes cannot passivate corrosion defects in aluminum current collectors and have poor high voltage stability, i.e., they decompose after about 4.2 V. Corrosion of aluminum current collectors also accelerates capacity fading. Therefore, it is desirable to improve the anodic stability of ionic liquid electrolytes in such a way that addresses their poor stability at high voltages and to enable high energy density batteries.

### SUMMARY

This section provides a general summary of the disclosure, and is not a comprehensive disclosure of its full scope or all of its features.

In various aspects, the current technology provides an ionic liquid electrolyte composition including an ionic liquid; a conductive salt; and optionally a stabilizing agent. The stabilizing agent may include a component selected from the group consisting of: an oxidant, an interface additive, a co-solvent, and combinations thereof.

In one variation, the ionic liquid includes a cation selected from the group consisting of an imidazolium cation, a pyrrolidinium cation, a piperidinium cation, N-trimethyl-N-butylammonium (TMBA), and combinations thereof.

In one variation, the ionic liquid includes an anion selected from the group consisting of bis(fluorosulfonyl)amide (FSI⁻), bis((trifluoromethyl)sulfonyl)amide (TFSI⁻), PF₆⁻, BF₄⁻, ClO₄⁻, and combinations thereof.

In one variation, the conductive salt is lithium bis(fluorosulfonyl)imide (LiFSI), lithium bis((trifluoromethyl)sulfonyl)amide (LiTFSI), LiPF₆, LiBF₄, LiClO₄, or a combination thereof.

In one variation, the ionic liquid electrolyte composition includes the stabilizing agent and the oxidant comprises LiClO₄, K₂Cr₂O₇, CsClO₄, NaClO₄, or a combination thereof.

In one variation, the ionic liquid electrolyte composition includes the stabilizing agent and the interface additive includes LiBF₂(C₂O₄), LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ), Li₂(B₁₀X_{10-i′}H_{i′}), or a combination thereof, where X is independently a halogen, 0≤i≤12, and 0≤i′≤10.

In one variation, the ionic liquid electrolyte composition includes the stabilizing agent and the co-solvent includes a cyclic fluorinated carbonate of Formula (I):

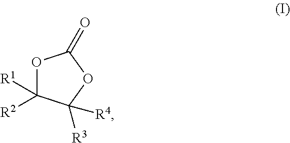

where each of R¹, R², R³, and R⁴ is individually, H, F, Cl, Br, I, CN, NO₂, alkyl, alkenyl, aryl, aralkyl, heterocyclyl, heteroaryl, or heteroaralkyl, with the proviso that at least one of R¹, R², R³, and R⁴ is F or contains F.

In one variation, each of R¹, R², R³, and R⁴ of Formula (I) is individually H, F, C₁-C₈ alkyl, or C₁-C₈ fluoroalkyl.

In one variation, R¹, R², and R³ are H and R⁴ is F; le and R² are H, and R³ and R⁴ are F; R² and R³ are H, and R¹ and R⁴ are F; any 3 of R¹, R², R³, and R⁴ are F and the remaining one of R¹, R², R³, and R⁴ is H; or R¹, R², R³, and R⁴ are each F.

In one variation, the ionic liquid electrolyte composition includes the stabilizing agent and the oxidant, the interface additive, the co-solvent, or the combination thereof has a concentration of greater than or equal to about 0.25 wt. % to less than or equal to about 5 wt. %, individually.

In one variation, the ionic liquid electrolyte composition includes the conductive salt at a concentration of greater than or equal to about 0.25 wt. % to less than or equal to about 5 wt. %, the co-solvent at a concentration of greater than or equal to about 1 wt. % to less than or equal to about 50 wt. % and at least one of the oxidant at a concentration of greater than or equal to about 0.25 wt. % to less than or equal to about 5 wt. % and the interface additive at a concentration of greater than or equal to about 0.25 wt. % to less than or equal to about 5 wt. %.

In one variation, the ionic liquid includes 1-methyl-1-propylpryrrolidin-1-ium, the conductive salt is about 1 M lithium bis(fluorosulfonyl)imide (LiFSI), and the ionic liquid electrolyte composition includes the stabilizing agent, the stabilizing agent being about 10 wt. % fluoroethylene carbonate (FEC) or difluoroethylene carbonate (DFEC) and at least one of about 2 wt. % LiClO₄ and about 2 wt. % LiBF₂(C₂O₄) or LiB(C₂O₄)₂.

In one variation, the ionic liquid electrolyte composition is configured to be stable within an electrochemical cell operating at greater than or equal to about 4.2 V.

In one variation, the ionic liquid electrolyte composition is configured to be stable within an electrochemical cell having a cathode loading of from greater than or equal to about 1 mAh/cm² to less than or equal to about 5 mAh/cm² and operating at greater than or equal to about 4.2 V.

In various aspects, the current technology further provides an electrochemical cell. The electrochemical cell includes a porous separator disposed between a cathode and an anode; and an ionic liquid electrolyte composition disposed within the porous separator, the ionic liquid electrolyte composition including an ionic liquid; a conductive salt; and optionally a stabilizing agent including a component selected from the group consisting of: an oxidant, an interface additive, a co-solvent, and combinations thereof. The ionic liquid electrolyte composition is stable in the electrochemical cell when operating at a voltage greater than or equal to about 4.2 V.

In one variation, the cathode has an active material including spinel, olivine, carbon-coated olivine, LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0.

In one variation, the anode includes carbon (C), silicon (Si), tin (Sn), germanium (Ge), bismuth (Bi), zinc (Zn), tellurium (Te), lead (Pb), gallium (Ga), aluminum (Al), arsenic (As), lithium (Li), or combinations thereof.

In one variation, the active material is selected from the group consisting of lithium manganese oxide (LMO), lithium manganese nickel oxide (LNMO), lithium cobalt oxide (LCO), lithium nickel oxide (LNO), lithium nickel manganese cobalt oxide (NMC), lithium nickel cobalt metal oxide (NCA), mixed oxides of lithium iron phosphates, lithium iron polyanion oxide, lithium titanate, and combinations thereof.

In one variation, the electrochemical cell has a cycling efficiency of greater than or equal to about 70% to less than or equal to about 99.9%.

In various aspects, the current technology yet further provides a method of preparing an ionic liquid electrolyte composition. The method includes mixing a conductive salt with an ionic liquid to form the ionic liquid electrolyte composition; and optionally mixing a stabilizing agent with the ionic liquid electrolyte composition, wherein the stabilizing agent includes a component selected from the group consisting of: an oxidant, an interface additive, a co-solvent, and combinations thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an electrochemical cell in accordance with various aspects of the current technology.

FIG. 2 is a graph of capacity (mAh/g) and efficiency (%) vs. cycle number for an electrochemical cell with a Li metal anode and low loading NCM622 cathode and having a 1 M LiFSI salt in N-methyl-N-propylpyrrolidinium bis(flourosulfonyl)imide (Py13FSI) electrolyte without a stabilizing agent of the current technology. The electrochemical cell is tested under an upper cutoff voltage of 4-4.3V, with 10 cycles for each voltage.

FIG. 3 is a graph of capacity (mAh/g) and efficiency (%) vs. cycle number for an electrochemical cell with an a Li metal anode and a low loading NCM622 cathode. The electrolyte is 1 M LiFSI in Py13FSI with 2 wt. % lithium di-fluoro(oxalatto)borate (LiDFOB) in accordance with various aspects of the current technology. The electrochemical cell is tested under an upper cutoff voltage of 4-4.5 V, with 10 cycles for each voltage.

FIG. 4 is a graph of capacity (mAh/g) and efficiency (%) vs. cycle number for an electrochemical cell with a Li metal anode and a low loading NCM622 cathode. The electrolyte is 1 M LiFSI in Py13FSI with 2 wt. % lithium bis(oxalato)borate (LiBOB) in accordance with various aspects of the current technology. The electrochemical cell is tested under an upper cutoff voltage of 4-4.5 V, with 10 cycles for each voltage.

FIG. 5 is a graph of capacity (mAh/g) and efficiency (%) vs. cycle number for an electrochemical cell with a Li metal anode and a low loading NCM622 cathode. The electrolyte is 1 M LiFSI in Py13FSI with 2 wt. % lithium perchlorate in accordance with various aspects of the current technology. The electrochemical cell is tested under an upper cutoff voltage of 4-4.5 V, with 10 cycles for each voltage.

FIG. 6 is a graph of capacity (mAh/g) vs. cycle number for two electrochemical cells with Li metal anodes and high loading NCM622 cathodes. The electrolyte of a first of the electrochemical cells is 1 M LiFSI in Py13FSI. The electrolyte of the a second of the electrochemical cells is 1 M LiFSI in Py13FSI with 2 wt. % lithium perchlorate in accordance with various aspects of the current technology. The electrochemical cells are tested under an upper cutoff voltage of 4-4.5 V, with 10 cycles for each voltage.

FIG. 7 is Nyquist plot for the second electrochemical cell of FIG. 6 having the electrolyte of 1 M LiFSI in Py13FSI with 2 wt. % lithium perchlorate in accordance with various aspects of the current technology.

FIG. 8 is a graph of capacity (mAh/g) vs. cycle number for electrochemical cells with Li metal anodes and high loading NCM622 cathodes. The second of the electrochemical cells, as described with regard to FIGS. 6 and 7, has an electrolyte of 1 M LiFSI in Py13FSI with 2 wt. % lithium perchlorate. A third electrochemical cell has an electrolyte of 1 M LiFSI in Py13FSI electrolyte with 10 wt. % fluoroethylene carbonate (FEC) in accordance with various aspects of the current technology. A fourth of the electrochemical cell has an electrolyte of 1 M LiFSI in Py13FSI electrolyte with 2 wt. % lithium perchlorate and 10 wt. % FEC in accordance with various aspects of the current technology. The electrochemical cells are tested under an upper cutoff voltage of 4-4.5 V, with 10 cycles for each voltage.

FIG. 9 is a graph of capacity (mAh/g) and efficiency (%) vs. cycle number for an electrochemical cell with a Li metal anode and a high loading LG622 cathode. The electrolyte is 1 M LiFSI in Py13FSI with 2 wt. % lithium perchlorate and 10 wt. % FEC in accordance with various aspects of the current technology. The electrochemical cell is cycled between 3-4.4 V.

FIG. 10A is a graph of capacity (mAh/g) and efficiency (%) vs. cycle number for an electrochemical cell having a Si/graphite cathode and a Li metal anode. The electrolyte is 1.2 M LiPF₆ in EC/EMC 3/7 volume ratio.

FIG. 10B is a graph of capacity (mAh/g) and efficiency (%) vs. cycle number for an electrochemical cell having a Si/graphite cathode and a Li metal anode. The electrolyte is 1.2 M LiPF₆ in EC/EMC 3/7 volume ratio with 10 wt. % FEC.

FIG. 10C is a graph of capacity (mAh/g) and efficiency (%) vs. cycle number for an electrochemical cell having a Si/graphite cathode and a Li metal anode. The electrolyte is 1 M LiFSI in Py13FSI.

FIG. 11A is a graph of capacity (mAh/g) and efficiency (%) vs. cycle life for an electrochemical cell having a Si/graphite anode and a NCM622 cathode. The electrolyte is 1 M LiFSI in Py13FSI.

FIG. 11B is a scanning electron microscopy (SEM) image of a cathode harvested from the electrochemical cell described in FIG. 11A. The scale bar is 10 μm.

FIG. 11C is a graph of capacity (mAh/g) and efficiency (%) vs. cycle number for electrochemical cells having Si/graphite anodes and NCM622 cathodes. The electrolyte is 1 M LiFSI in Py13FSI in a first of the electrochemical cells and 1 M LiFSI in Py13FSI with 2 wt. % LiClO₄ in a second of the electrochemical cells.

FIG. 11D is a graph of coulombic efficiency (%) vs. cycle number for the electrochemical cells described in regard to FIG. 11C.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to improved ionic liquids as electrolytes for high energy secondary batteries. More particularly, the current technology provides an ionic liquid electrolyte composition that includes a conductive salt and an optional stabilizing agent that enables a higher voltage stability relative to corresponding cells having the same ionic liquid electrolyte, but without the conductive salt and optional stabilizing agent. The ionic liquid electrolyte compositions of the current technology are useful in high voltage cells, such as cells that operate at above about 4.2 V, and have energy densities that are higher than in equivalent cells that do not include the conductive salt and optional stabilizing agent.

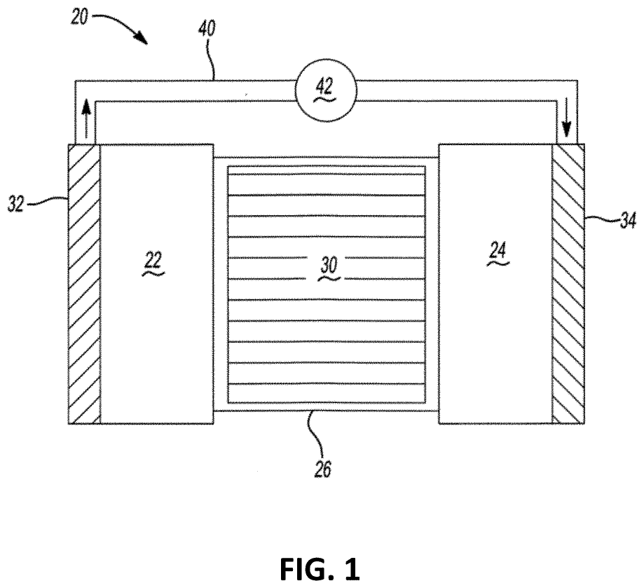

In various aspects, the ionic liquid electrolytes according to certain aspects of the present technology can be used in an electrochemical cell, such as an electrochemical cell that cycles lithium ions (e.g., lithium ion batteries, lithium metal batteries, lithium primary batteries, and lithium sulfur batteries), an electrochemical cell that cycles sodium ions (e.g., sodium ion batteries, sodium metal batteries, sodium primary batteries, and sodium sulfur batteries), or a capacitor. Accordingly, FIG. 1 provides an exemplary schematic illustration of an electrochemical cell 20. The electrochemical cell 20 includes a negative electrode 22, a negative current collector 32 in contact with the negative electrode 22, a positive electrode 24, a positive current collector 34 in contact with the positive electrode 24, and a separator 26 disposed between the negative and positive electrodes 22, 24. The negative electrode 22 may be referred to herein as an anode and the positive electrode 24 as a cathode. In certain instances, each of the negative current collector 32, negative electrode 22, separator 26, positive electrode 24, and positive current collector 34 may be assembled in layers connected in electrical parallel arrangement to provide a suitable energy package.

The negative electrode 22 includes an electroactive material as a lithium host material capable of functioning as a negative terminal of a lithium ion battery. By way of example only, the electroactive material may comprise a compound comprising carbon (C, such as graphite), silicon (Si), tin (Sn), germanium (Ge), bismuth (Bi), zinc (Zn), tellurium (Te), lead (Pb), gallium (Ga), aluminum (Al), arsenic (As), lithium (Li) (e.g., Li metal), or combinations thereof. In certain instances, the negative electrode 22 may further include a polymeric binder material to structurally fortify the electroactive material.

The negative current collector 32 may be positioned at or near the negative electrode 22. The negative current collector 32 may comprise a relatively ductile metal or metal alloy that is electrically conductive. The negative current collector 32 may include a compound selected from the group consisting of gold (Au), lead (Pb), niobium (Nb), palladium (Pd), platinum (Pt), silver (Ag), vanadium (V), copper (Cu), tantalum (Ta), nickel (Ni), iron (Fe), and combinations thereof.

The separator 26 positioned between the negative electrode 22 and the positive electrode 24 may operate as both an electrical insulator and a mechanical support, preventing physical contact and, consequently, the occurrence of a short circuit. Further, the separator 26, in addition to providing a physical barrier between the negative and positive electrodes 22, 24, may provide a minimal resistance path for internal passage of lithium ions (and related anions) for facilitating functioning of the electrochemical cell 20.

The separator 26 may be porous having a plurality of pores defined therein, for example, comprising a microporous polymeric separator including a polyolefin. The polyolefin may be a homopolymer (e.g., derived from a single monomer constituent) or a heteropolymer (e.g., derived from more than one monomer constituent), which may be either linear or branched. If a heteropolymer is derived from two monomer constituents, the polyolefin may assume any copolymer chain arrangement, including that of a block copolymer or a random copolymer. Similarly, if the polyolefin is a heteropolymer derived from more than two monomer constituents, it may likewise be a block copolymer or a random copolymer. For example only, the polyolefin may be polyethylene (PE), polypropylene (PP), or a combination thereof.

The separator 26, as a microporous polymeric separator, may be a single layer or a multi-layer laminate, which may be fabricated from either a dry or wet process. In certain instances, a single layer of the polyolefin may form the entire microporous polymer separator 26. In other instances, the separator 26 may be a fibrous membrane having an abundance of pores extending between the opposing surfaces and may have a thickness of less than a millimeter. In still other instances, multiple discrete layers of similar or dissimilar polyolefins may be assembled to form the microporous polymer separator 26. The microporous polymer separator 26 may include other polymers in addition to the polyolefin. For example only, the separator 26 may also include polyethylene terephthalate (PET), polyvinylidene fluoride (PVDF), and/or a polyamide. The polyolefin layer and any other optional polymer layers may be included in the microporous polymer separator 26 as a fibrous layer and may provide the microporous polymer separator 26 with appropriate structural and porosity characteristics.

The porous separator 26 includes an electrolyte 30 disposed within pores of the separator that is capable of conducting lithium ions. The electrolyte 30 is disposed within the separator 26, such as on surface of and within pores of the separator 26. The electrolyte 30 may also be present in the negative electrode 22 and positive electrode 24. The electrolyte 30 of the current technology is an ion liquid electrolyte composition that is discussed in more detail below.

The positive electrode 24 may be formed, for example, from a lithium-based active material that can sufficiently undergo lithium intercalation/alloying and deintercalation/dealloying, while functioning as the positive terminal of the electrochemical cell 20. In certain instances, layered lithium transitional metal oxides may be used to form the positive electrode 24. For example only, the positive electrode 24 may comprise an active material of lithium manganese oxide (LMO) of Li₍₁₊ₓ₎Mn₍₂₋ₓ₎O₄, where 0≤x≤1 (e.g., LiMn₂O₄); lithium manganese nickel oxide (LNMO) of LiMn₍₂₋ₓ₎NiₓO₄, where 0≤x≤1 (e.g., LiMn_{1.5}Ni_{0.5}O₄); lithium cobalt oxide (LCO, e.g., LiCoO₂); lithium nickel oxide (LNO, e.g., LiNiO₂); lithium nickel manganese cobalt oxide (NMC) of Li_{1+α}(NiₓMn_{y}Co_{z})O₂), where 0≤α≤1, 0≤x≤1, 0≤y≤1, 0≤z≤1, and x+y+z=1 (e.g., LiMn_{0.33}Ni_{0.33}Co_{0.33}O₂); lithium nickel cobalt metal oxide (NCA) of LiNi_{(1-x-y)}CoₓM_{y}O₂), where 0<x<1, 0<y<1 and M may be Al, Mn, or the like (e.g., LiNI_{0.8}Co_{0.15}Al_{0.05}O₂); mixed oxides of lithium iron phosphates; lithium iron polyanion oxide (e.g., lithium iron phosphate (LiFePO₄) or lithium iron fluorophosphate (Li₂FePO₄F)); lithium titanate, or a combination thereof. In various embodiments, the cathode active material comprises spinel, olivine, carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0. In certain instances, the positive electrode 24 may further include a polymeric binder material that structurally fortifies the lithium-based active material. In certain instances, the active materials of the positive electrode 24 may be intermingled with at least one polymeric binder by slurry casting active materials with such binders. However, it is understood that the active material can include sodium, such as in embodiments where the electrochemical cell is a sodium ion battery.

The positive current collector 34 may be positioned at or near the positive electrode 24. The positive current collector 34 may comprise a relatively ductile metal or metal alloy that is electrically conductive. The positive current collector 34 may include a compound selected from the group consisting of gold (Au), lead (Pb), niobium (Nb), palladium (Pd), platinum (Pt), silver (Ag), vanadium (V), aluminum (Al), tantalum (Ta), nickel (Ni), and combinations thereof.

The negative current collector 32 and positive current collector 34 may respectively collect and move free electrons to and from an external circuit 40. The external circuit 40 and a load device 42 may connect the negative electrode 22 through its current collector 32 and the positive electrode 24 through its current collector 34. The electrochemical cell 20 may generate an electric current during discharge by way of reversible electrochemical reactions that occur when the external circuit 40 is closed (e.g., the negative electrode 22 is connected to the positive electrode 24) and the negative electrode 22 contains a greater relative quantity of intercalated lithium. The chemical potential difference between the positive electrode 24 and the negative electrode 22 may drive electrons produced by the oxidation of intercalated lithium at the negative electrode 22 through the external circuit 40 toward the positive electrode 24. Lithium ions, which may also be produced at the negative electrode, may be concurrently transferred through the electrolyte 30 and the separator 26 towards the positive electrode 24. The electrons may flow through the external circuit 40 and the lithium ions may migrate across the separator 26 in the electrolyte 30 to form intercalated lithium at the positive electrode 24. The electric current passing through the external circuit 40 may be harnessed and directed through the load device 42 until the intercalated lithium in the negative electrode 22 is depleted and the capacity of the electrochemical cell 20 diminished.

The electrochemical cell 20 may be charged or re-powered at any time by connecting an external power source to the electrochemical cell 20 to reverse the electrochemical reactions that occur during battery discharge. The connection of an external power source to the electrochemical cell 20 may facilitate the otherwise non-spontaneous oxidation of intercalated lithium at the positive electrode 24 to produce electrons and lithium ions. The electrons, which may flow back towards the negative electrode 22 through the external circuit 40, and the lithium ions, which may be carried by the electrolyte 30 across the separator 26 back towards the negative electrode 22, may reunite at the negative electrode 22 and replenish the negative electrode 22 with intercalated lithium for consumption during the next discharge cycle of the electrochemical cell 20. The external power source that may be used to charge the electrochemical cell 20 may vary depending on the size, construction, and particular end-use of the electrochemical cell 20. For example only, the external power source may be an AC wall outlet or a motor vehicle alternator.

The size and shape of the electrochemical cell 20 may vary depending on the particular application for which it is designed. In certain instances, the electrochemical cell 20 may also be connected in series or parallel with other similar lithium ion cells or batteries to produce a greater voltage output and power density if it is required by the load device 42. The load device 42 may be powered fully or partially by the electric current passing through the external circuit 40 when the electrochemical cell 20 is discharging. For example only, the load device 42 may be an electric motor for a hybrid vehicle or an all-electrical vehicle, a laptop computer, a tablet computer, a cellular phone, or a cordless power tool or appliance. In certain instances, the load device 42 may be a power-generating apparatus that charges the electrochemical cell 20 for purposes of storing energy.

The ionic liquid electrolyte composition of the current technology comprises an ionic liquid and a conductive salt (dissolved in the ionic liquid). Accordingly, the ionic liquid includes a cation and an anion. The cation of the ionic liquid is an imidazolium cation, a pyrrolidinium cation, a piperidinium cation, N-trimethyl-N-butylammonium (TMBA), or a combination thereof, as non-limiting examples. Non-limiting examples of imidazolium cations include 3-ethyl-1-methyl-1H-imidazol-3-ium, 3-allyl-1-methyl-1H-imidazol-3-ium, 3-butyl-1-methyl-1H-imidazol-3-ium, and combinations thereof. Non-limiting examples of pyrrolidinium cations include 1-butyl-1-methylpyrrolidin-1-ium, 1-methyl-1-propylpyrrolidin-1-ium (Py13), 1-(2-methoxyethyl)-1-methylpyrrolidin-1-ium, 1-methyl-1-pentylpyrrolidin-1-ium, and combinations thereof. Non-limiting examples of piperidinium cations include 1-methyl-1-propylpiperidin-1-ium, 1-butyl-1-methylpiperidin-1-ium, and combinations thereof. The anion of the ionic liquid salt is bis(fluorosulfonyl)amide (FSI), bis((trifluoromethyl)sulfonyl)amide (TFSI), PF₆⁻, BF₄⁻, ClO₄⁻, or a combination thereof. The conductive salt can be, as a non-limiting examples, lithium bis(fluorosulfonyl)imide (LiFSI), lithium bis((trifluoromethyl)sulfonyl)amide (LiTFSI), LiPF₆, LiBF₄, LiClO₄, or a combination thereof. The conductive salt has a concentration in the ionic liquid of greater than or equal to about 0.01 M to less than or equal to about 2 M, greater than or equal to about 0.1 M to less than or equal to about 1.75 M, greater than or equal to about 0.25 M to less than or equal to about 1.5 M, or greater than or equal to about 0.5 M to less than or equal to about 1.25 M, such as a concentration of about 0.01 M, about 0.1 M, about 0.2 M, about 0.25 M, about 0.3 M, about 0.4 M, about 0.5 M, about 0.6 M, about 0.7 M, about 0.75 M, about 0.8 M, about 0.9 M, about 1 M, about 1.01 M, about 1.1 M, about 1.2 M, about 1.25 M, about 1.3 M, about 1.4 M, about 1.5 M, about 1.6 M, about 1.7 M, about 1.75 M, about 1.8 M, about 1.9 M, or about 2 M.

The ionic liquid electrolyte composition of the current technology further includes an optional stabilizing agent (dissolved in the ionic liquid), which stabilizes electrochemical cells that operate under an upper cutoff voltage of greater than or equal to about 4 V to less than or equal to about 5 V. It is understood that the electrolyte of the current technology is also stable at voltages below 4 V.

The stabilizing agent is at least one of an oxidant, an interface additive, and a co-solvent. As a non-limiting example, in some embodiments, the stabilizing agent comprises the co-solvent and at least one of the oxidant and the interface additive. In another non-limiting example, in other embodiments, the stabilizing agent comprises the oxidant and at least one of the interface additive and the co-solvent.

The oxidant stabilizes the ionic liquid and conductive salt at high voltages. The oxidant is LiClO₄, K₂Cr₂O₇, CsClO₄, NaClO₄, or a combination thereof, as non-limiting examples. The oxidant is included in the ionic liquid electrolyte composition and present in the electrolyte at a concentration (wt. %, based on the total weight of the ionic liquid electrolyte composition) of greater than or equal to about 0.25 wt. % to less than or equal to about 5 wt. %, greater than or equal to about 0.5 wt. % to less than or equal to about 4 wt. %, greater than or equal to about 1 wt. % to less than or equal to about 3 wt. %, or greater than or equal to about 1.5 wt. % to less than or equal to about 2.5 wt. %, such as a concentration of about 0.25 wt. %, about 0.5 wt. %, about 0.75 wt. %, about 1 wt. %, about 1.25 wt. %, about 1.5 wt. %, about 1.75 wt. %, about 2 wt. %, about 2.25 wt. %, about 2.5 wt. %, about 2.75 wt. %, about 3 wt. %, about 3.25 wt. %, about 3.5 wt. %, about 3.75 wt. %, about 4 wt. %, about 4.25 wt. %, about 4.5 wt. %, about 4.75 wt. %, about 5 wt. %, or higher. However, it is understood that the oxidant can be included in the ionic liquid electrolyte composition at any concentration, with the proviso that the oxidant remains solubilized in the ionic liquid.

The interface additive serves as a cathode electrolyte interface (CEI) or anode solid electrolyte interface (SEI) additive that stabilizes at least one of the cathode and anode at the high voltage and high current density. Non-limiting examples of the interface additive include LiBF₂(C₂O₄) (LiDFOB), LiB(C₂O₄)₂ (LiBOB), LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ), Li₂(B₁₀X_{10-i′}H_{i′}), and combinations thereof, where each X is independently a halogen (e.g., F, Cl, Br, or I), 0≤i≤12, and 0≤i′≤10. The interface additive is included in the ionic liquid electrolyte composition and is present in the electrolyte at a concentration (wt. %, based on the total weight of the ionic liquid electrolyte composition) of greater than or equal to about 0.25 wt. % to less than or equal to about 5 wt. %, greater than or equal to about 0.5 wt. % to less than or equal to about 4 wt. %, greater than or equal to about 1 wt. % to less than or equal to about 3 wt. %, or greater than or equal to about 1.5 wt. % to less than or equal to about 2.5 wt. %, such as a concentration of about 0.25 wt. %, about 0.5 wt. %, about 0.75 wt. %, about 1 wt. %, about 1.25 wt. %, about 1.5 wt. %, about 1.75 wt. %, about 2 wt. %, about 2.25 wt. %, about 2.5 wt. %, about 2.75 wt. %, about 3 wt. %, about 3.25 wt. %, about 3.5 wt. %, about 3.75 wt. %, about 4 wt. %, about 4.25 wt. %, about 4.5 wt. %, about 4.75 wt. %, about 5 wt. %, or higher. However, it is understood that the interface additive can be included in the ionic liquid electrolyte composition in any concentration, with the proviso that the interface additive remains solubilized in the ionic liquid.

The co-solvent is an SEI additive that stabilizes the anode and decreases the viscosity of the ionic liquid. The co-solvent is a cyclic fluorinated carbonate, including carbonates of Formula (I):

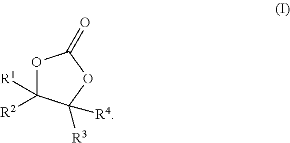

In Formula (I), each of R¹, R², R³, and R⁴ is individually, H, F, Cl, Br, I, CN, NO₂, alkyl, alkenyl, aryl, aralkyl, heterocyclyl, heteroaryl, or heteroaralkyl, with the proviso that at least one of R¹, R², R³, and R⁴ is F or contains F. In some embodiments, each of R¹, R², R³, and R⁴ is individually, H, F, C₁-C₈ alkyl, or C₁-C₈ fluoroalkyl. In some other embodiments, each of R¹, R², and R³ are H and R⁴ is F; or wherein each of R¹ and R² are H, and R³ and R⁴ are F; or wherein each of R² and R³ are H, and R¹ and R⁴ are F; or wherein any 3 of R¹, R², R³, and R⁴ are F and the remaining one of R¹, R², R³, and R⁴ is H; or wherein R¹, R², R³, and R⁴ are each F. In some embodiments, the co-solvent of Formula (I) comprises at least one of the following fluorinated carbonates:

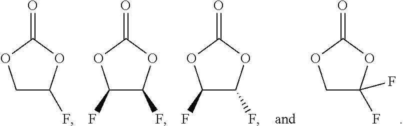

The ionic liquid electrolyte composition includes the co-solvent in the electrolyte at a concentration (wt. %, based on the total weight of the ionic liquid electrolyte composition) of greater than or equal to about 1 wt. % to less than or equal to about 50 wt. %, greater than or equal to about 2.5 wt. % to less than or equal to about 40 wt. %, greater than or equal to about 5 wt. % to less than or equal to about 30 wt. %, or greater than or equal to about 7.5 wt. % to less than or equal to about 20 wt. %, such as a concentration of about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 25 wt. %, about 30 wt. %, about 35 wt. %, about 40 wt. %, about 45 wt. %, about 50 wt. %, or higher. It is understood that the ionic liquid electrolyte composition can include the co-solvent at any concentration, with the proviso that the stabilizing agent remains solubilized in the ionic liquid.

The ionic liquid electrolyte composition is stable in batteries having a low cathode active material loading, such as an active material loading of greater than or equal to about 0.5 mAh/cm² to less than about 2 mAh/cm² or greater than or equal to about 1.25 mAh/cm² to less than or equal to about 1.75 mAh/cm², such as an active material loading of about 0.5 mAh/cm², about 0.75 mAh/cm², about 1 mAh/cm², about 1.25 mAh/cm², about 1.5 mAh/cm², about 1.75 mAh/cm², or about 2 mAh/cm². In some embodiments, the cathode has a low cathode active material loading and the stabilizing agent includes only one of the oxidizing agent, the interface additive, and the co-solvent.

The ionic liquid electrolyte composition is also stable in batteries having a high cathode active material loading, such as an active material loading of greater than or equal to about 2 mAh/cm² to less than or equal to about 5 mAh/cm², greater than or equal to about 3 mAh/cm² to less than or equal to about 4.75 mAh/cm², or greater than or equal to about 4 mAh/cm² to less than or equal to about 4.5 mAh/cm², such as an active material loading of about 2 mAh/cm², about 2.5 mAh/cm², about 2.75 mAh/cm², about 3 mAh/cm², about 3.25 mAh/cm², about 3.5 mAh/cm², about 3.75 mAh/cm², about 4 mAh/cm², about 4.25 mAh/cm², about 4.5 mAh/cm², about 4.75 mAh/cm², or about 5 mAh/cm². With a high cathode active material loading, the stabilizing agent stabilizes at least one of the cathode and the anode and can include at least one of the oxidizing agent, the interface additive, and the co-solvent. Moreover, the ionic liquid electrolyte composition provides a cycling efficiency in batteries having a high cathode active material loading of greater than or equal to about 70%, greater than or equal to about 80%, greater than or equal to about 85%, greater than or equal to about 90%, greater than or equal to about 95%, or greater than or equal to about 97.5%. In some embodiments, the cycling efficiency is greater than or equal to about 70% to less than or equal to about 99.9%, greater than or equal to about 80% to less than or equal to about 99.9%, about 85% to less than or equal to about 99.9%, about 90% to less than or equal to about 99.9%, or about 95% to less than or equal to about 99.9%. In some embodiments, the cathode has a high cathode active material loading and the stabilizing agent includes the oxidant and at least one of the interface additive and the co-solvent or the co-solvent and at least one of the oxidant and the interface additive.

The current technology also includes an electrochemical cell comprising a porous separator disposed between a cathode and an anode, with the ionic liquid electrolyte composition disposed about the separator. The electrochemical cell is described in more detail above with reference to FIG. 1. The ionic liquid electrolyte composition is stable in the electrochemical cell when operating at a high voltage as described above, e.g., at a voltage of greater than or equal to about 4 V or greater than or equal to about 4.2 V.

The cathode has a low active material loading or a high active material loading. Accordingly, in various embodiments the cathode active material loading is greater than or equal to about 1 mAh/cm² to less than or equal to about 5 mAh/cm². The active material is selected from, as non-limiting examples, the group consisting of lithium manganese oxide (LMO), lithium manganese nickel oxide (LNMO), lithium cobalt oxide (LCO), lithium nickel oxide (LNO), lithium nickel manganese cobalt oxide (NMC), lithium nickel cobalt metal oxide (NCA), mixed oxides of lithium iron phosphates, lithium iron polyanion oxide, lithium titanate, and combinations thereof. The electrochemical cell has a cycling efficiency of greater than or equal to about 70% to less than or equal to about 99.9%, greater than or equal to about 80% to less than or equal to about 99.9%, about 85% to less than or equal to about 99.9%, about 90% to less than or equal to about 99.9%, or about 95% to less than or equal to about 99.9%.

The current technology also provides a method of preparing the ionic liquid electrolyte composition. The method comprises combining (and mixing) a conductive salt with an ionic liquid, such that the conductive salt dissolves in the ionic liquid, to form the ionic liquid electrolyte composition. The method optionally further comprises combining (and mixing) a stabilizing agent with the ionic liquid electrolyte composition. As described herein, the stabilizing agent comprises an oxidant, an interface additive, a co-solvent, or a combination thereof.

Embodiments of the present technology are further illustrated through the following non-limiting examples.

### EXAMPLE 1

Methods.

3-4.2 V constant current charge and discharge (CC-CD) under the rate of C/10 formation is used for two cycles. Different upper cutoff voltages CC-CD C/2 cycling are utilized in the procedure from 4 V to 4.5 V.

Results.

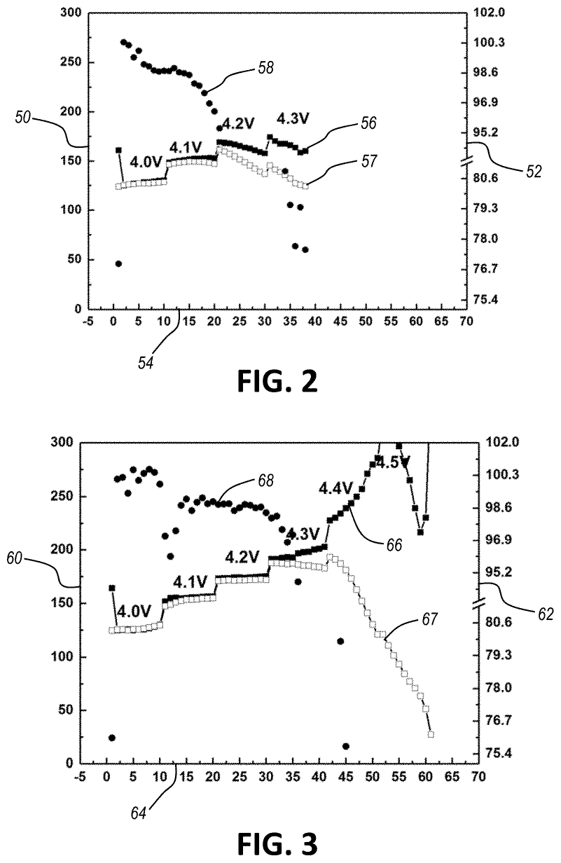

An electrochemical cell including a low loading NCM622 cathode, a Li metal anode, and an electrolyte of Py13FSI with 1 M LiFSI is cycled. The results are shown in FIG. 2, which is a graph having a first y-axis 50 representing capacity (mAh/g), a second y-axis 52 representing efficiency, and an x-axis 54 representing cycle number. A first curve 56 shows charge capacity, a second curve 57 shows discharge capacity, and a third curve 58 shows efficiency. As shown in FIG. 2, the electrochemical cell breaks down after 4.1 V due to a high voltage instability of the ionic liquid electrolyte.

An electrochemical cell including a low loading NCM622 cathode, a Li metal anode, and an electrolyte of Py13FSI with 1 M LiFSI and 2 wt. % lithium difluoro(oxalato)borate (LiDFOB) is cycled. The results are shown in FIG. 3, which is a graph having a first y-axis 60 representing capacity (mAh/g), a second y-axis 62 representing efficiency, and an x-axis 64 representing cycle number. A first curve 66 shows charge capacity, a second curve 67 shows discharge capacity, and a third curve 68 shows efficiency. As shown in FIG. 3, due to the addition of LiDFOB, the upper cutoff voltage is improved to 4.2 V.

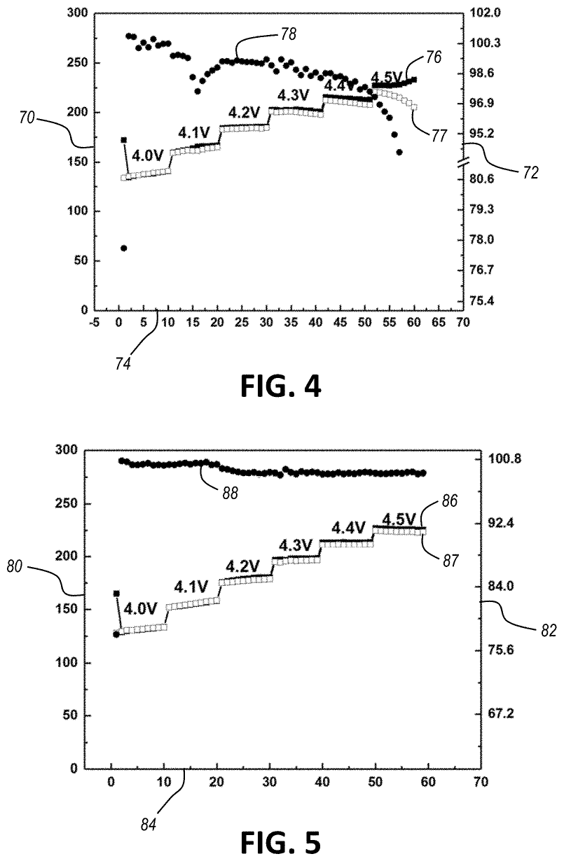

An electrochemical cell including a low loading NCM622 cathode, a Li metal anode, and an electrolyte of Py13FSI with 1 M LiFSI and 2 wt. % lithium bis(oxalate)borate (LiBOB) is cycled. The results are shown in FIG. 4, which is a graph having a first y-axis 70 representing capacity (mAh/g), a second y-axis 72 representing efficiency, and an x-axis 74 representing cycle number. A first curve 76 shows charge capacity, a second curve 77 shows discharge capacity, and a third curve 78 shows efficiency. As shown in FIG. 4, the addition of LiBOB allows the cell to be cycled up to 4.4 V.

An electrochemical cell including a low loading NCM622 cathode, a Li metal anode, and an electrolyte of Py13FSI with 1 M LiFSI and 2 wt. % LiClO₄ is cycled. The results are shown in FIG. 5, which is a graph having a first y-axis 80 representing capacity (mAh/g), a second y-axis 82 representing efficiency, and an x-axis 84 representing cycle number. A first curve 86 shows charge capacity, a second curve 87 shows discharge capacity, and a third curve 88 shows efficiency. As shown in FIG. 5, the addition of LiClO₄ improves the anodic stability of the cell to cycle on 4.5 V.

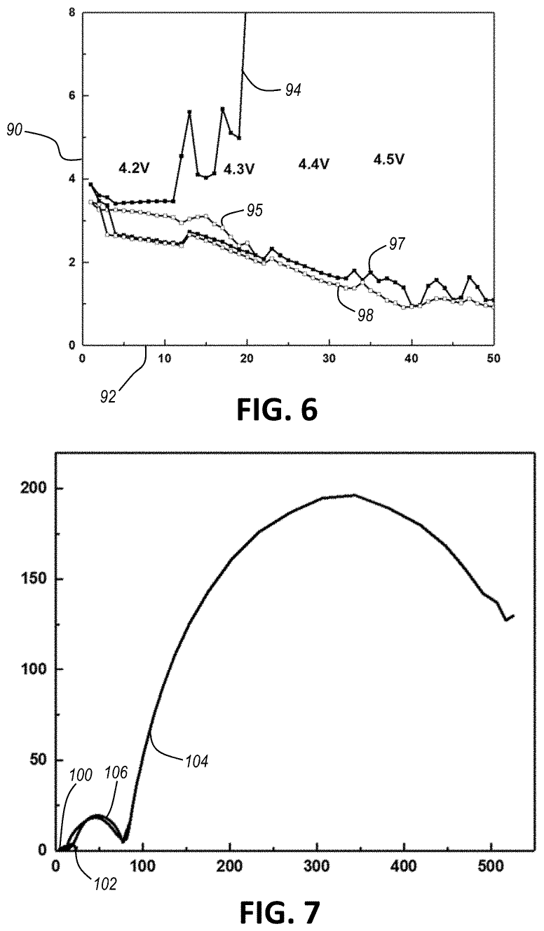

A first electrochemical cell including a high loading NCM622 cathode, a Li metal anode, and an electrolyte of Py13FSI with 1 M LiFSI is cycled. A second electrochemical cell including a high loading NCM622 cathode, a Li metal anode, and an electrolyte of Py13FSI with 1 M LiFSI and 2 wt. % LiClO₄ is also cycled. The results are shown in FIG. 6, which is a graph having a y-axis 90 representing capacity (mAh/g) and an x-axis 92 representing cycle number. A first curve 94 shows charge capacity and a second curve 95 shows discharge capacity for the first electrochemical cell. A third curve 97 shows charge capacity and a fourth curve 98 shows discharge capacity for the second electrochemical cell. As shown in FIG. 6, the first electrochemical cell cannot cycle above 4.3 V, but the second electrochemical cell can cycle above 4.3 V, but with fading capacity. The impedance of the second electrochemical cell is shown in the Nyquist plot of FIG. 7. This plot shows a first impedance curve 100 after formation, a second impedance curve 102 after cycling at 4.2 V, a third impedance curve 104 after cycling at 4.3 V, and a fourth impedance curve 106 after cycling at 4.4 V. As shown in FIG. 7, the second electrochemical cell degrades due to impedance build-up after 4.2 V.

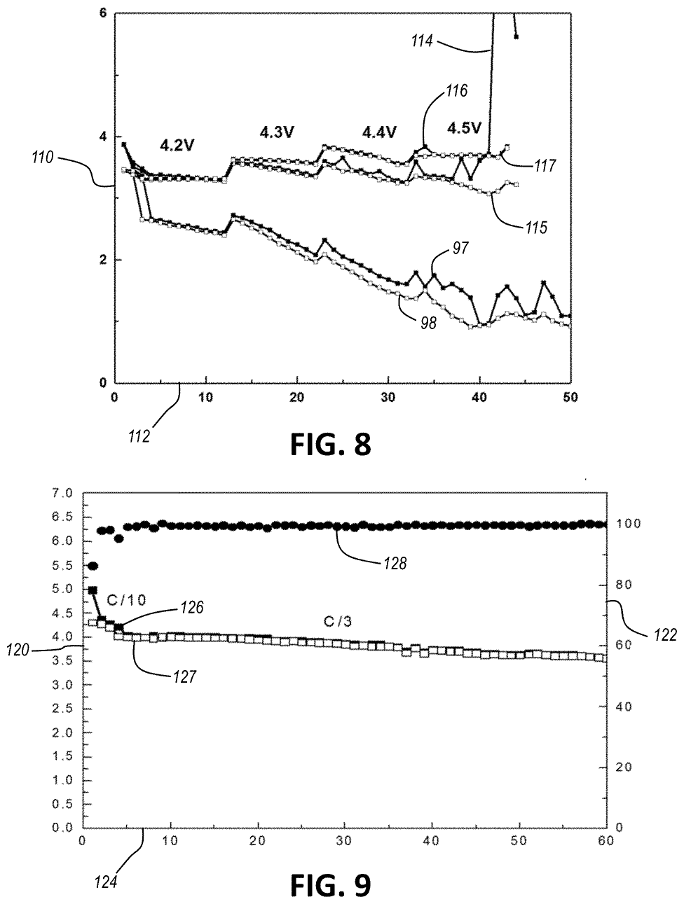

A third electrochemical cell including a high loading NCM622 cathode, a Li metal anode, and an electrolyte of Py13FSI with 1 M LiFSI and 10 wt. % FEC is cycled. A fourth electrochemical cell including a high loading NCM622 cathode, a Li metal anode, and an electrolyte of Py13FSI with 1 M LiFSI, 10 wt. % FEC and 2 wt. % LiClO₄ is also cycled The results are shown in FIG. 8, which is a graph having a y-axis 110 representing capacity (mAh/g) and an x-axis 112 representing cycle number. The third curve 97 and the fourth curve 98 from FIG. 6 are shown in the graph for reference. A fifth curve 114 shows charge capacity and a sixth curve 115 shows discharge capacity for the third electrochemical cell, while a seventh curve 116 shows charge capacity and an eighth curve 117 shows discharge capacity for the fourth electrochemical cell. As shown in FIG. 8, the third electrochemical cell cycles to 4.4 V and the fourth electrochemical cell cycles through 4.5 V. The third and fourth electrochemical cells have improved capacity retention relative to the first and second electrochemical cells.

An electrochemical cell including a high loading LG622 cathode, a Li metal anode, and an electrolyte of Py13FSI with 1 M LiFSI, 2 wt. % LiClO₄, and 10 wt. % FEC is cycled. The results are shown in FIG. 9, which is a graph having a first y-axis 120 representing capacity (mAh/g), a second y-axis 122 representing efficiency, and an x-axis 124 representing cycle number. A first curve 126 shows charge capacity, a second curve 127 shows discharge capacity, and a third curve 128 shows efficiency. As shown in FIG. 9, the electrochemical cell is stable through 60 cycles.

### EXAMPLE 2

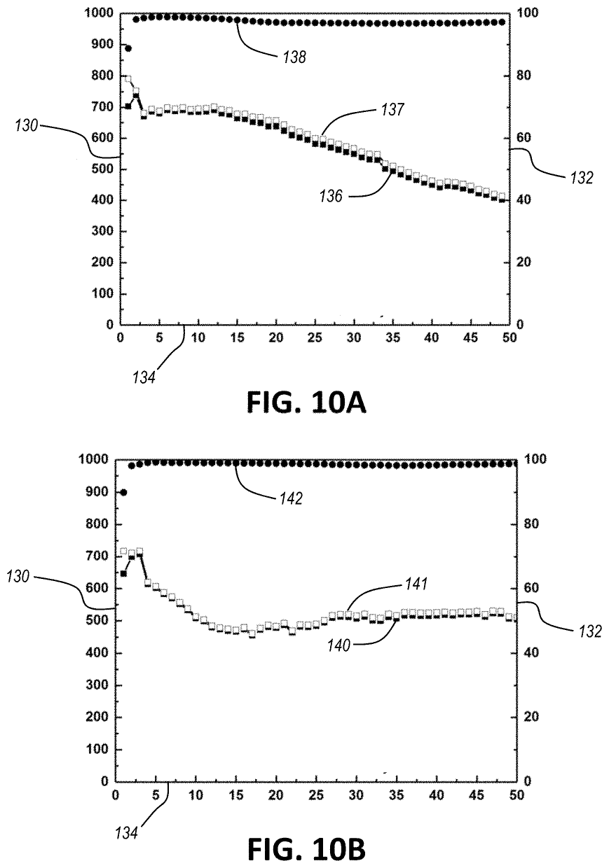

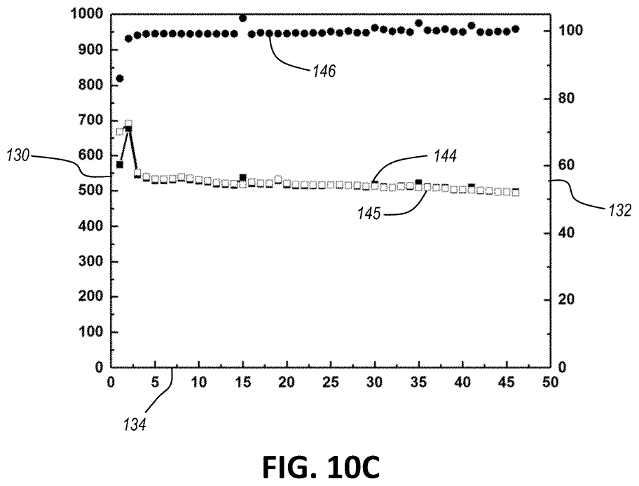

An ionic liquid electrolyte composition is used to initiate a Si electrode. Electrochemical cells include a 60 μm lithium chip anode and a cathode with 15% Hitachi Mage 130808 nano-sized and amorphous silicon. FIGS. 10A, 10B, and 10C show graphs having a first y-axis 130 representing capacity (mAh/g), a second y-axis 132 representing efficiency (%), and an x-axis 134 representing cycle number. FIG. 10A shows a first curve 136 showing charge capacity, a second curve 137 showing discharge capacity, and third curve 138 showing efficiency in an electrochemical cell having a “Gen2” electrolyte of 1.2 M LiPF₆ in ethylene carbonate/ethyl-methyl carbonate (EC/EMC=3/7 as a volume ratio). FIG. 10B shows a first curve 140 showing charge capacity, a second curve 141 showing discharge capacity, and a third curve 142 showing efficiency in an electrochemical cell having a Gen2 electrolyte of 1.2 M LiPF₆ and 10 wt. % FEC in EC/EMC (3/7 volume ratio). FIG. 10C shows a first curve 144 showing charge capacity, a second curve 145 showing discharge capacity, and a third curve 146 showing efficiency in an electrochemical cell having an electrolyte of 1 M LiFSI in Py13FSI. FIGS. 10A-10C show that, unlike traditional EC-based electrolytes, the ionic liquid (FIG. 10C) forms a good passivation layer on the Si electrode, which enables cycling.

### EXAMPLE 3

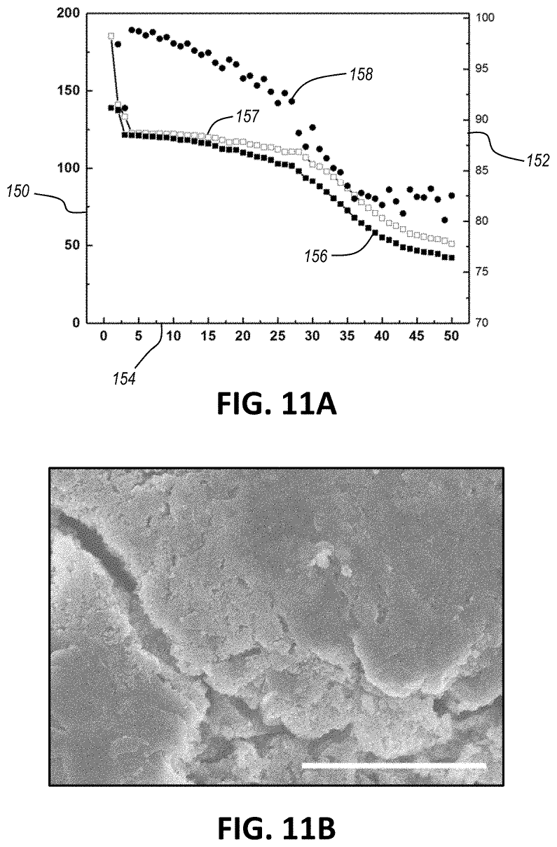

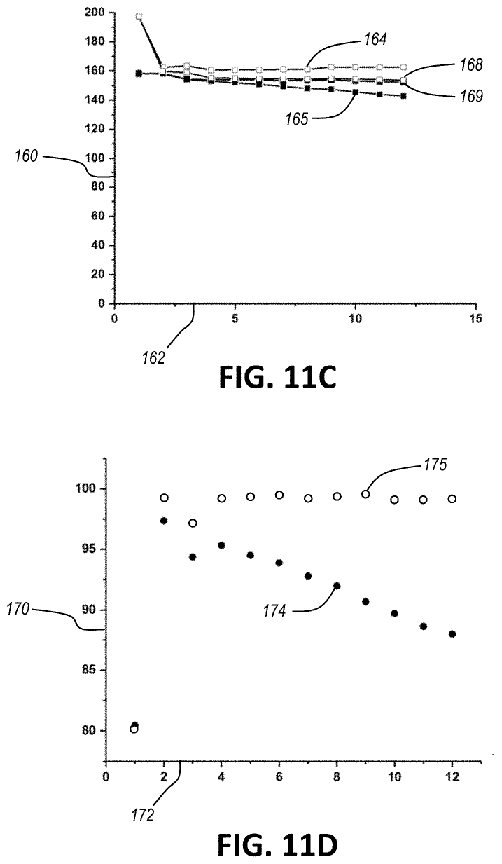

An ionic liquid electrolyte composition is used to initiate a Si anode with a NCM622 cathode in a high voltage lithium ion battery. A first electrochemical cell includes a 15% Si@graphite anode, a NCM622 cathode, and an electrolyte of 1 M LiFSI in Py13FSI. FIG. 11A shows a graph having a first y-axis 150 representing area capacity (mAh/g), a second y-axis 152 representing efficiency (%), and an x-axis 154 representing cycle life (number). A first curve 156 shows discharge capacity, a second curve 157 shows charge capacity, and a third curve 158 shows efficiency for the first electrochemical cell. The first electrochemical cell has a 4.2 V cut off. FIG. 11B is a scanning electron microscopy (SEM) image of the harvested cathode of the first electrochemical cell, which shows electrolyte decomposition. FIGS. 11A and 11B show that the ionic liquid can passivate the Si electrode successfully, but suffers from anodic instability.

A second and a third electrochemical cell each include a 15% prelithiated Si@graphite anode and a NCM622 cathode. The second electrochemical cell has an electrolyte of 1 M LiFSI in Py13FSI. The third electrochemical cell has an electrolyte of 1 M LiFSI in Py13FSI and 2 wt. % LiClO₄. FIG. 11C shows a graph having a y-axis 160 representing specific capacity (mAh/g) and an x-axis 163 representing cycle number. A first curve 164 shows charge capacity and a second curve 165 shows discharge capacity for the second electrochemical cell. A third curve 168 shows charge capacity and a fourth curve 169 shows discharge capacity for the third electrochemical cell. FIG. 11D shows a graph having a y-axis 170 representing coulombic efficiency (%) and an x-axis 172 representing cycle number. A first curve 174 shows efficiency for the second electrochemical cell and a second curve 175 shows efficiency for the third electrochemical cell. FIGS. 11C and 11D show that the addition of LiClO₄ improves anodic stability relative to the first electrochemical cell and enables the Si/NMC high voltage battery up to 4.2 V

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An ionic liquid electrolyte composition comprising:
an ionic liquid;
a conductive salt; and
optionally a stabilizing agent that comprises a component selected from the group consisting of: an oxidant, an interface additive, a co-solvent, and combinations thereof.

2. The ionic liquid electrolyte composition according to claim 1, wherein the ionic liquid comprises a cation selected from the group consisting of an imidazolium cation, a pyrrolidinium cation, a piperidinium cation, N-trimethyl-N-butylammonium (TMBA), and combinations thereof.

3. The ionic liquid electrolyte composition according to claim 1, wherein the ionic liquid comprises an anion selected from the group consisting of bis(fluorosulfonyl)amide (FSI⁻), bis((trifluoromethyl)sulfonyl)amide (TFSI⁻), PF₆⁻, BF₄⁻, ClO₄⁻, and combinations thereof.

4. The ionic liquid electrolyte composition according to claim 1, wherein the conductive salt is lithium bis(fluorosulfonyl)imide (LiFSI), lithium bis((trifluoromethyl)sulfonyl)amide (LiTFSI), LiPF₆, LiBF₄, LiClO₄, or a combination thereof.

5. The ionic liquid electrolyte composition according to claim 1, wherein the ionic liquid electrolyte composition comprises the stabilizing agent and the oxidant comprises LiClO₄, K₂Cr₂O₇, CsClO₄, NaClO₄, or a combination thereof.

6. The ionic liquid electrolyte composition according to claim 1, wherein the ionic liquid electrolyte composition comprises the stabilizing agent and the interface additive comprises LiBF₂(C₂O₄), LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ), Li₂(B₁₀X_{10-i′}H_{i′}), or a combination thereof, where X is independently a halogen, 0≤i≤12, and 0≤i′≤10.

7. The ionic liquid electrolyte composition according to claim 1, wherein the ionic liquid electrolyte composition comprises the stabilizing agent and the co-solvent comprises a cyclic fluorinated carbonate of Formula (I): 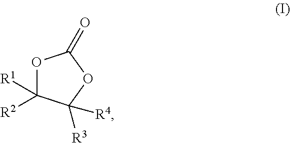
where each of R¹, R², R³, and R⁴ is individually, H, F, Cl, Br, I, CN, NO₂, alkyl, alkenyl, aryl, aralkyl, heterocyclyl, heteroaryl, or heteroaralkyl, with the proviso that at least one of R¹, R², R³, and R⁴ is F or contains F.

8. The ionic liquid electrolyte composition according to claim 7, wherein each of R¹, R², R³, and R⁴ of Formula (I) is individually H, F, C₁-C₈ alkyl, or C₁-C₈ fluoroalkyl.

9. The ionic liquid electrolyte composition according to claim 7, wherein:
R¹, R², and R³ are H and R⁴ is F;
R¹ and R² are H, and R³ and R⁴ are F;
R² and R³ are H, and R¹ and R⁴ are F;
any 3 of R¹, R², R³, and R⁴ are F and the remaining one of R¹, R², R³, and R⁴ is H; or
R¹, R², R³, and R⁴ are each F.

10. The ionic liquid electrolyte composition according to claim 1, wherein the ionic liquid electrolyte composition comprises the stabilizing agent and the oxidant, the interface additive, the co-solvent, or the combination thereof has a concentration of greater than or equal to about 0.25 wt. % to less than or equal to about 5 wt. %, individually.

11. The ionic liquid electrolyte composition according to claim 1, wherein the ionic liquid electrolyte composition comprises the conductive salt at a concentration of greater than or equal to about 0.25 wt. % to less than or equal to about 5 wt. %, the co-solvent at a concentration of greater than or equal to about 1 wt. % to less than or equal to about 50 wt. % and at least one of the oxidant at a concentration of greater than or equal to about 0.25 wt. % to less than or equal to about 5 wt. % and the interface additive at a concentration of greater than or equal to about 0.25 wt. % to less than or equal to about 5 wt. %.

12. The ionic liquid electrolyte composition according to claim 1, wherein the ionic liquid comprises 1-methyl-1-propylpryrrolidin-1-ium, the conductive salt is about 1 M lithium bis(fluorosulfonyl)imide (LiFSI), and the ionic liquid electrolyte composition comprises the stabilizing agent, the stabilizing agent being about 10 wt. % fluoroethylene carbonate (FEC) or difluoroethylene carbonate (DFEC) and at least one of about 2 wt. % LiClO₄ and about 2 wt. % LiBF₂(C₂O₄) or LiB(C₂O₄)₂.

13. The ionic liquid electrolyte composition according to claim 1, wherein the ionic liquid electrolyte composition is configured to be stable within an electrochemical cell operating at greater than or equal to about 4.2 V.

14. The ionic liquid electrolyte composition according to claim 1, wherein the ionic liquid electrolyte composition is configured to be stable within an electrochemical cell having a cathode loading of from greater than or equal to about 1 mAh/cm² to less than or equal to about 5 mAh/cm² and operating at greater than or equal to about 4.2 V.

15. An electrochemical cell comprising:
a porous separator disposed between a cathode and an anode; and
an ionic liquid electrolyte composition disposed within the porous separator, the ionic liquid electrolyte composition comprising an ionic liquid; a conductive salt; and optionally a stabilizing agent comprising a component selected from the group consisting of: an oxidant, an interface additive, a co-solvent, and combinations thereof, wherein the ionic liquid electrolyte composition is stable in the electrochemical cell when operating at a voltage greater than or equal to about 4.2 V.

16. The electrochemical cell according to claim 15, wherein the cathode has an active material comprising spinel, olivine, carbon-coated olivine, LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{z-z′}F_{z′}, VO₂ or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4;and 0≤x″≤3; with the proviso that at least one of h, k and l is greater than 0.

17. The electrochemical cell according to claim 15, wherein the anode comprises carbon (C), silicon (Si), tin (Sn), germanium (Ge), bismuth (Bi), zinc (Zn), tellurium (Te), lead (Pb), gallium (Ga), aluminum (Al), arsenic (As), lithium (Li), or combinations thereof.

18. The electrochemical cell according to claim 16, wherein the active material is selected from the group consisting of lithium manganese oxide (LMO), lithium manganese nickel oxide (LNMO), lithium cobalt oxide (LCO), lithium nickel oxide (LNO), lithium nickel manganese cobalt oxide (NMC), lithium nickel cobalt metal oxide (NCA), mixed oxides of lithium iron phosphates, lithium iron polyanion oxide, lithium titanate, and combinations thereof.

19. The electrochemical cell according to claim 15, wherein the electrochemical cell has a cycling efficiency of greater than or equal to about 70% to less than or equal to about 99.9%.

20. A method of preparing an ionic liquid electrolyte composition, the method comprising:
mixing a conductive salt with an ionic liquid to form the ionic liquid electrolyte composition; and optionally mixing a stabilizing agent with the ionic liquid electrolyte composition, wherein the stabilizing agent comprises a component selected from the group consisting of: an oxidant, an interface additive, a co-solvent, and combinations thereof.
